(19) United States
(12) Patent Application Publication
(10) Pub. No.: US 2026/0246627 A1
(43) Pub. Date: Aug. 20, 2026

(54) SECURE COMMUNICATION FOR INTERNET OF THINGS (IOT) DEVICES

(71) Applicant: Cypress Semiconductor Corporation, San Jose, CA (US)

(72) Inventors: Pradeep Sreedhar, Bengaluru (IN); Varun Kaushik, Bengaluru (IN); Deepak Naik, Uttarakannada (IN)

(73) Assignee: Cypress Semiconductor Corporation, San Jose, CA (US)

(21) Appl. No.: 19/055,056

(22) Filed: Feb. 17, 2025

(51) Int. Cl. H04L 9/08; H04L 9/32

(52) U.S. Cl. CPC H04L 9/0866; H04L 9/3268

(57) ABSTRACT

An encrypted authentication credentials of an internet of things (IoT) device is identified. A decryption key is generated using a set of immutable identifier of the IoT device, a decryption key. The encrypted authentication credentials are decrypted using the decryption key to generate a decrypted authentication credentials. A secure communication between the IoT device and a server is established using the decrypted authentication credentials.

### TECHNICAL FIELD

Aspects and implementations of the present disclosure relate to secure communication of Internet of Things (IoT) devices.

### BACKGROUND

The Internet of Things (IoT) ecosystem comprises distributed networks of interconnected devices enabling automated data collection and communication across diverse applications. IoT devices require secure storage of unique device credentials for authenticated communication with clouds. Current protection mechanisms using common encryption keys across similar devices create significant vulnerabilities, as compromising one device potentially exposes all devices sharing that key. This invention provides an improved method for protecting device credentials in IoT systems.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example IoT ecosystem, in accordance with implementations of the present disclosure.

FIG. 2 illustrates an example authentication component of an IoT device of the IoT ecosystem of FIG. 1, in accordance with implementations of the present disclosure.

FIG. 3 depicts a flow diagram of an example method for training a reinforcement learning agent for adaptive offloading, in accordance with implementations of the present disclosure.

FIG. 4 is a block diagram illustrating an exemplary computer system, in accordance with implementations of the present disclosure.

### DETAILED DESCRIPTION

Aspects of the present disclosure relate to secure communication of IoT devices. The IoT ecosystem are distributed networks that enable automated data collection, processing, and communication across various applications. IoT ecosystems comprise multiple interconnected IoT devices and supporting infrastructure to enable data exchange. IoT ecosystems operate in diverse environments, from smart homes to industrial automation, requiring robust security measures to protect sensitive data and ensure authenticated communication.

IoT devices have become integral components of IoT ecosystems, functioning as data collection and communication endpoints within IoT ecosystem architecture. IoT devices require unique device credentials, including device-specific keys and certificates, stored in flash memory. Device-specific keys enable cryptographic operations that prove device identity during communications. Certificates are issued by trusted authorities and provide verification that an IoT device is genuine and authorized to access a cloud. When an IoT device communicates with a cloud, an IoT device uses credentials to establish encrypted connections, preventing unauthorized access to the cloud or impersonation of legitimate IoT devices.

Current protection mechanisms employ an encryption approach where device credentials are encrypted using a common encryption key shared across all IoT devices of the same type. During manufacturing, the common encryption key is programmed into each IoT device, and the common encryption key is used to encrypt unique device credentials before storing the encrypted unique device credentials in flash memory. During operation, an IoT device uses the common encryption key to decrypt device credentials whenever secure communication is required.

However, current protection mechanisms introduce a significant security vulnerability in IoT devices. If an attacker compromises the common encryption key from any single IoT device, the attacker can potentially decrypt and access device credentials of all IoT devices sharing that same common encryption key. As a result, a single successful attack compromises security of all IoT devices of the same type, highlighting a need for improved methods of protecting device credentials in IoT ecosystems.

Aspects and embodiments of the present disclosure address these and other limitations of the existing technology by including an authentication component, in IoT devices, that decrypts encrypted authentication credentials using immutable identifiers of the IoT device.

Based on symmetric encryption, the authentication credentials are encrypted and decrypted in similar manners, for example, using the same encryption key. Accordingly, the authentication credentials are encrypted by combining immutable identifiers of the IoT device to generate an encryption key. The immutable identifiers of the IoT device can include a device identifier and/or a firmware identifier, both stored in read-only memory. The device identifier uniquely distinguishes each IoT device, while the firmware identifier identifies the installed firmware. The encryption key is a string of bits used to encrypt and decrypt data. The encryption key may be a predefined bit length as defined by a symmetric block cipher algorithm. The encryption key is generated, for example, by combining the immutable identifiers of the IoT device.

During operations of the IoT device, the IoT device may initiate a secure communication with a cloud. In response to initiation of the secure communication with the cloud, an authentication component obtains the immutable identifiers of the IoT device. The authentication component combines the immutable identifiers to generate the encryption key. The authentication component decrypts, using the generated encryption key, the encrypted authentication credentials. After decryption, the IoT device uses the decrypted authentication credentials to establish secure communication with the cloud.

Aspects of the present disclosure overcome these deficiencies by improving security of the authentication credentials during manufacturing, as well as preventing single successful attacks that compromise security of all IoT devices of similar type. Additionally, providing flexibility in storage of the authentication credentials

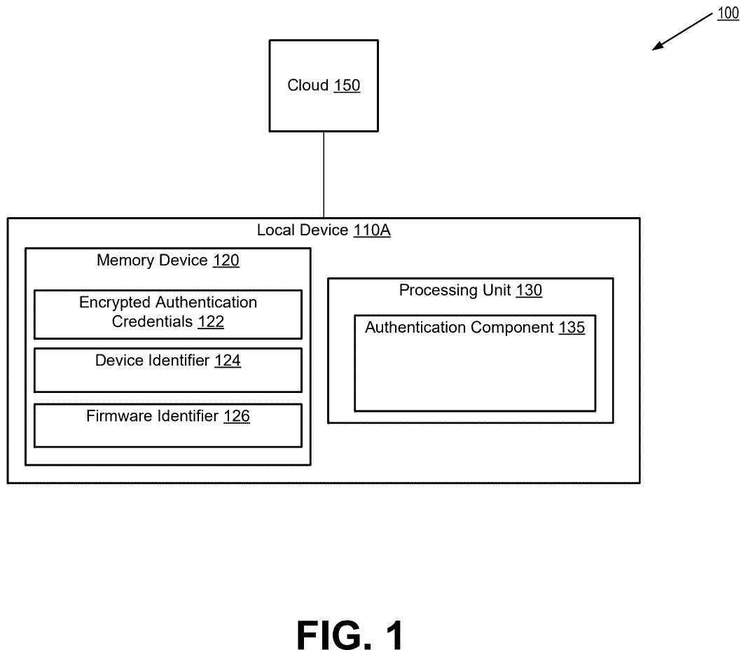

FIG. 1 illustrates an IoT ecosystem 100, in accordance with implementations of the present disclosure. The IoT ecosystem 100 includes IoT device 110 and a cloud 150. The IoT device 110 may a memory device 120 and a processing unit 130. The memory device 120 includes an encrypted authentication credentials 122, a device identifier 124, and a firmware identifier 126. The memory device 120 and the processing unit 130 in conjunction with sensor(s), actuator(s), communication modules, and other necessary interfaces, work together to collect data, process information, and interact with its environment. The cloud 150 may include a distributed collection of computing, storage, and networking resources designed to process, store, and analyze large volumes of data from the IoT device 110 while providing flexible, on-demand services.

The encrypted authentication credentials 122 refers to authentication credentials that has been encrypted. The authentication credentials include a device-specific key used to enable cryptographic operations to prove an IoT device identify and a certificate to provide verification that an IoT device is genuine and authorized to access a cloud. The authentication credentials, in symmetric encryption, must be encrypted and decrypted in the same manner.

The authentication credentials for IoT device 110 are encrypted, during manufacturing, using the device identifier 124 and the firmware identifier 126 of the IoT device 110. The device identifier of the IoT device is an immutable unique value that distinguishes one IoT device from another. For example, the device identifier of the IoT device may be an alphanumeric serial number, a hexadecimal MAC address, a universally unique identifier (UUID), a combination of product identifier and unit number, or a device name with location code. Device identifiers are assigned during manufacturing and permanently stored in read-only memory, ensuring they cannot be modified after manufacturing. The firmware identifier of the IoT device is an immutable value that identifies the firmware installed on the IoT device. For example, the firmware identifier of the IoT device may be a version number, a build identifier, a checksum value, or a cryptographic hash of the firmware image. Firmware identifiers are generated during firmware creation and stored in read-only memory, ensuring they cannot be modified after installation.

The authentication credentials are encrypted using the device identifier 124 and the firmware identifier 126 of the IoT device 110 by generating an encryption key. The encryption key is a string of bits used to encrypt and decrypt data, such as the authentication credentials, and may be a predefined bit length as defined a symmetric block cipher algorithm, such as Advanced Encryption Standard (AES). For example, AES-128 has a predetermined key length of 128-bit, AES-192 has a predetermined key length of 192-bit, and AES-256 has a predetermined key length of 256-bit, longer key lengths provide stronger security but require more processing resources.

The encryption key is generated, for example, by combining the device identifier 124 and the firmware identifier 126 of the IoT device 110. The device identifier 124 and the firmware identifier 126 of the IoT device 110 can be combined through (i) concatenation, (ii) byte alternation, (iii) pseudo-random interleaving, and/or (iv) cryptographic hashing.

Concatenation of the device identifier 124 and the firmware identifier 126 to generate the encryption key includes appending all bytes of the device identifier 124 immediately after all bytes of the firmware identifier 126 (or vice versa) in their original sequential order, maintaining the complete and unmodified byte sequences of both the device identifier 124 and the firmware identifier 126 while joining them into a single combined value where the device identifier 124 occupies the first portion and the firmware identifier 126 occupies the second portion of the encryption key (or vice versa).

Byte alternation of the device identifier 124 and the firmware identifier 126 to generate the encryption key includes sequentially interleaving bytes, where a first predetermined number of byte of the device identifier 124 is followed by a first predetermined number of byte of the firmware identifier 126, then a second predetermined number of byte of the device identifier 124 is followed by a second predetermined number of byte of the firmware identifier 126, continuing this alternating pattern through all bytes of the device identifier 124 and the firmware identifier 126. This byte-by-byte alternating combination creates a deterministic interleaved pattern that maintains the original byte order from each value while combining them in a fixed sequence.

Pseudo-random interleaving of the device identifier 124 and the firmware identifier 126 to generate the encryption key includes using a predefined seed value that initializes a deterministic pseudo-random number generator that produces a consistent sequence determining the interleaving pattern of bits from the device identifier 124 and the firmware identifier 126, thereby ensuring the combination can be reproducibly generated while appearing randomly arranged.

Cryptographic hashing of the device identifier 124 and the firmware identifier 126 to generate the encryption key includes first concatenating the device identifier 124 and the firmware identifier 126 in sequential order (or other combination methods), then applying a cryptographic hash function to the concatenated value to generate a fixed-length hash value. The cryptographic hash function ensures that the device identifier 124 and the firmware identifier 126 consistently produce the same hash result while making it computationally infeasible to derive the original device identifier 124 and firmware identifier 126 from the hash result.

It should be noted that while specific embodiments describe combining the device identifier 124 and the firmware identifier 126 using concatenation, byte alternation, pseudo-random interleaving, and cryptographic hashing, other mathematical operations and combination methods known in the art may be employed for combining the device identifier 124 and the firmware identifier 126 without departing from the scope of the present disclosure.

In some embodiments, the combination of the device identifier 124 and the firmware identifier 126 may have a key size that differs from a predetermined key length of the symmetric block cipher algorithm. As a result, the combination may be adjusted through truncation or padding operations. If the key size of the combination exceeds the predetermined key length of the symmetric block cipher algorithm, the excess bits or bytes may be truncated by selecting a subset of the combination. Conversely, if the combination is shorter than the predetermined key length of the symmetric block cipher algorithm, padding bits or bytes may be appended to extend the combination. The padding may comprise zeros, ones, or a predetermined pattern to achieve a key size that matches the predetermined key length of the symmetric block cipher algorithm while maintaining consistency in the combination process.

The encryption key, generated using the device identifier 124 and the firmware identifier 126, is used to encrypt the authentication credentials by processing the authentication credentials through the symmetric block cipher algorithm, such as AES-128, AES-192, or AES-256, transforming the authentication credentials into encrypted authentication credentials 122 that can only be decrypted back to the original authentication credentials using the same encryption key. Then, the encrypted authentication credentials 122 are programmed into memory device 120 of the IoT device 110 for use during operation.

During operation of the IoT device, the IoT device may initiate secure communication with cloud 150 to perform operations including transmission of collected sensor data, reception of firmware updates, reporting of device operational status, and response to pending cloud requests. Each of these operations requires a secure and authenticated connection to protect the data exchange between the IoT device 110 and cloud 150, thereby necessitating decryption of the encrypted authentication credentials. Thus, in response to initiation of a secure communication with the cloud 150, the processing unit 120 which includes an authentication component 135 decrypts the encrypted authentication credentials 122 stored in the memory device 130 for secure communication.

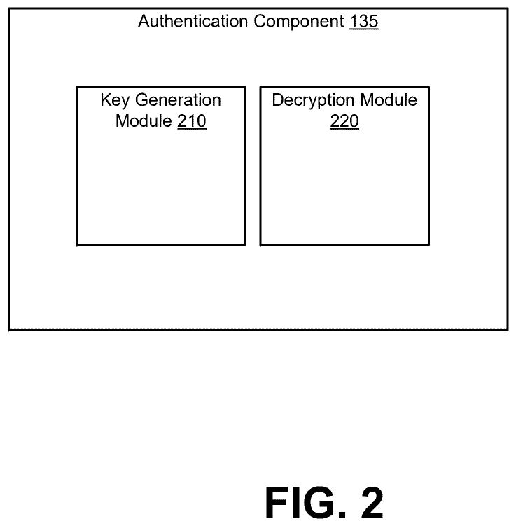

In particular, with reference to FIG. 2, a key generation module 210 of the authentication component 135 of FIG. 1 retrieves the device identifier 124 and the firmware identifier 126 from memory device 130. The key generation module 210 generates an encryption key to decrypt the encrypted authentication credentials 122. In particular, the key generation module 210 combines the device identifier 124 and the firmware identifier 126 using (i) concatenation, (ii) byte alternation, (iii) pseudo-random interleaving, and/or (iv) cryptographic hashing to generate the encryption key. Depending on the embodiment, the authentication component 135 may include details regarding the method of combining used to generate the encryption key for encrypting the authentication credentials.

With continued reference to FIG. 2, a decryption module 220 of the authentication component 135 of FIG. 1, once the encryption key is generated, passes the encrypted authentication credentials 122 and the encryption key through the symmetric block cipher algorithm in reverse order of the encryption steps, using the same key size and mode of operation that were used for encryption. As a result, transforming the encrypted authentication credentials 122 back to the original authentication credentials. Once the original authentication credentials are obtained, it is used to establish secure communication with the cloud 150.

Depending on the embodiment, the authentication component 135 may not be loaded on the IoT device 110 during manufacturing, but rather available to download to the IoT device 110 by a bootloader during operation (or runtime). Thus, all elements required for generating the original authentication credentials is not present on the IoT device 110, thereby compromising the security of the authentication component.

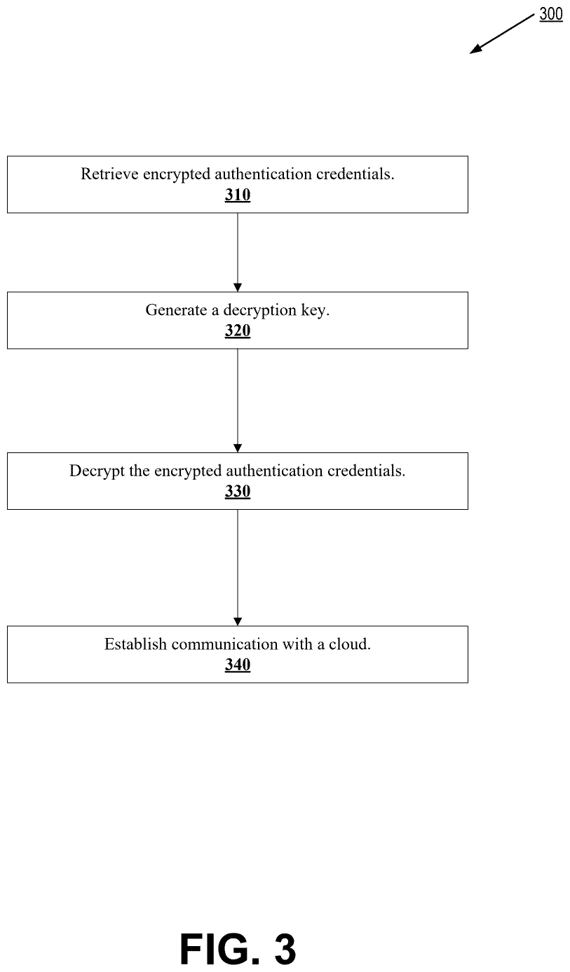

FIG. 3 is a flow diagram of a method 300 for secure communication of IoT devices, in accordance with implementations of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the authentication component 135.

At operation 310, the processing logic retrieves encrypted authentication credentials. As previously described, authentication credentials which includes a device-specific key, and a certificate is generated for an IoT device and stored in the memory device of the IoT device. The encrypted authentication credentials are generated by encrypting, during manufacturing, the authentication credentials using immutable identifiers of the IoT device which includes a device identifier (or a first immutable identifier) and a firmware identifier (or a second immutable identifier). More specifically, the device identifier and the firmware identifier are combined to generate an encryption key using one or more combination methods, such as concatenation, byte alternation, pseudo-random interleaving, or cryptographic hashing. The encryption key and the authentication credentials are passed through a symmetric block cipher algorithm, such as AES, to generate the encrypted authentication credentials.

At operation 320, the processing logic generates a decryption key. As previously described, the immutable identifiers of the IoT device may be stored in the IoT device. Thus, generating the decryption key includes retrieving, from the memory device of the IoT device, the immutable identifiers of the IoT device and combining the immutable identifiers in the same manner they were combined for the encryption key.

At operation 330, the processing logic decrypts the encrypted authentication credentials. As previously described, the decryption key and the encrypted authentication credentials are passed through the symmetric block cipher algorithm, such as AES, in reverse order to generate the original authentication credentials (or the decrypted authentication credentials). At operation 340, the processing logic establishes communication with a cloud. The IoT device uses the authentication credentials to prove its identity during communications and verify its authenticity and authorization to the cloud server.

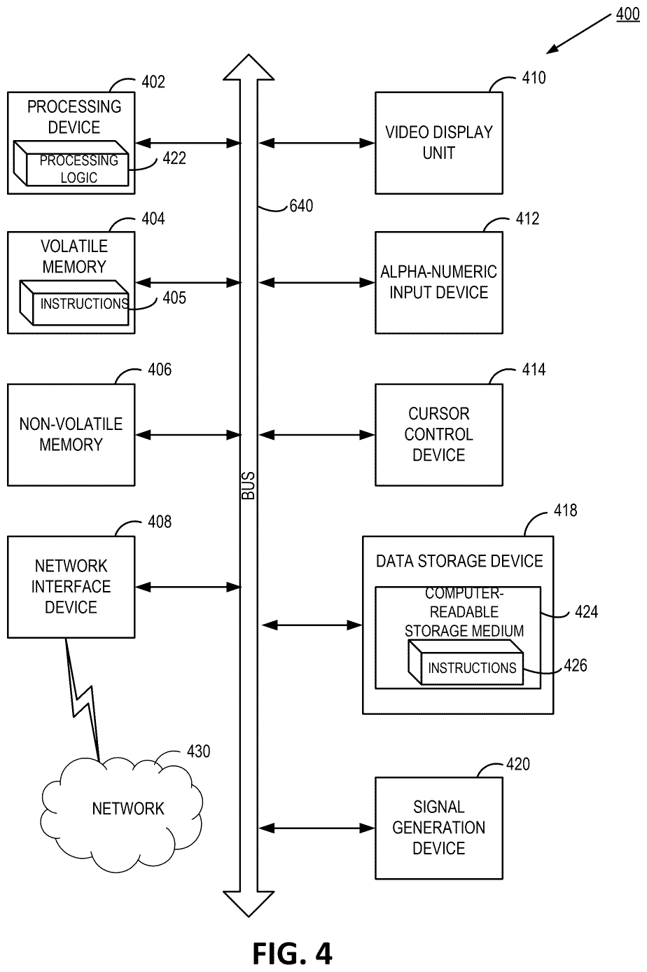

FIG. 4 is a block diagram illustrating an exemplary computer system 400, in accordance with implementations of the present disclosure. Computer system 400 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processing device (processor) 402, a main memory 404 (e.g., read-only memory (ROM), flash memory, dynamic random access memory (DRAM) such as synchronous DRAM (SDRAM), double data rate (DDR SDRAM), or DRAM (RDRAM), etc.), a static memory 406 (e.g., flash memory, static random access memory (SRAM), etc.), and a data storage device 418, which communicate with each other via a bus 440.

Processor (processing device) 402 represents one or more general-purpose processing devices such as a microprocessor, central processing unit, or the like. More particularly, the processor 402 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 can also be one or more special-purpose processing devices such as an application specific integrated circuit (ASIC), a field programmable gate array (FPGA), a digital signal processor (DSP), network processor, or the like. The processor 402 can include processing logic 422 used to perform the operations discussed herein. The processor 402 is configured to execute instructions 405 for performing the operations discussed herein.

The computer system 400 can further include a network interface device 408. The computer system 400 also can include a video display unit 410 (e.g., a liquid crystal display (LCD) or a cathode ray tube (CRT)), an input device 412 (e.g., a keyboard, and alphanumeric keyboard, a motion sensing input device, touch screen), a cursor control device 414 (e.g., a mouse), and a signal generation device 420 (e.g., a speaker).

The data storage device 418 can include a non-transitory machine-readable storage medium 424 (also non-transitory computer-readable storage medium) on which is stored one or more sets of instructions 426 embodying any one or more of the methodologies or functions described herein. The instructions can also reside, completely or at least partially, within the main memory 404 and/or within the processor 402 during execution thereof by the computer system 400, the main memory 404 and the processor 402 also constituting machine-readable storage media. The instructions can further be transmitted or received over a network 430 via the network interface device 408.

While the computer-readable storage medium 424 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “comprises,” “comprising,” “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “block,” “layer,” “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution, and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a non-transitory computer-readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include a collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
identifying an encrypted authentication credentials of an internet of things (IoT) device;
generating, using a set of immutable identifier of the IoT device, a decryption key;
decrypting, using the decryption key, the encrypted authentication credentials to generate a decrypted authentication credentials; and
establishing, using the decrypted authentication credentials, a secure communication between the IoT device and a server.

2. The method of claim 1, wherein the encrypted authentication credentials of the IoT device are encrypted during manufacturing using the set of immutable identifier.

3. The method of claim 1, wherein the set of immutable identifiers includes at least a first immutable identifier and a second immutable identifier.

4. The method of claim 3, wherein the first immutable identifier is a device identifier of the IoT device.

5. The method of claim 3, wherein the second immutable identifier is a firmware identifier of the IoT device.

6. The method of claim 1, wherein generating the decryption key comprises:
combining the set of immutable identifiers to generate the decryption key having a key size based on a predetermined key length of a block cipher algorithm of the IoT device.

7. The method of claim 1, wherein the authentication credentials comprise a device-specific key and a certificate for establishing secure communication between the IoT device and the server.

8. A non-transitory computer-readable medium comprising instructions that, responsive to execution by a processing device, cause the processing device to perform operations comprising:
identifying an encrypted authentication credentials of an internet of things (IoT) device;
generating, using a set of immutable identifier of the IoT device, a decryption key;
decrypting, using the decryption key, the encrypted authentication credentials to generate a decrypted authentication credentials; and
establishing, using the decrypted authentication credentials, a secure communication between the IoT device and a server.

9. The non-transitory computer-readable medium of claim 8, wherein the encrypted authentication credentials of the IoT device are encrypted during manufacturing using the set of immutable identifier.

10. The non-transitory computer-readable medium of claim 8, wherein the set of immutable identifiers includes at least a first immutable identifier and a second immutable identifier.

11. The non-transitory computer-readable medium of claim 10, wherein the first immutable identifier is a device identifier of the IoT device.

12. The non-transitory computer-readable medium of claim 10, wherein the second immutable identifier is a firmware identifier of the IoT device.

13. The non-transitory computer-readable medium of claim 8, wherein generating the decryption key comprises:
combining the set of immutable identifiers to generate the decryption key having a key size based on a predetermined key length of a block cipher algorithm of the IoT device.

14. The non-transitory computer-readable medium of claim 8, wherein the authentication credentials comprise a device-specific key and a certificate for establishing secure communication between the IoT device and the server.

15. An internet of things (IoT) device comprising:
a processing device to perform operations comprising:
generating, using a set of immutable identifier of the IoT device, a decryption key;
decrypting, using the decryption key, an encrypted authentication credentials to generate a decrypted authentication credentials; and
establishing, using the decrypted authentication credentials, a secure communication with a server.

16. The IoT device of claim 15, wherein the encrypted authentication credentials of the IoT device are encrypted during manufacturing using the set of immutable identifier.

17. The IoT device of claim 15, wherein the set of immutable identifiers includes at least a first immutable identifier and a second immutable identifier.

18. The IoT device of claim 17, wherein the first immutable identifier is a device identifier of the IoT device, and the second immutable identifier is a firmware identifier of the IoT device.

19. The IoT device of claim 15, wherein generating the decryption key comprises:
combining the set of immutable identifiers to generate the decryption key having a key size based on a predetermined key length of a block cipher algorithm of the IoT device.

20. The IoT device of claim 15, wherein the authentication credentials comprise a device-specific key and a certificate for establishing secure communication with the server.
